(19) United States
(12) Patent Application Publication
(10) Pub. No.: US 2025/0034925 A1
(43) Pub. Date: Jan. 30, 2025

(54) FURNITURE DRIVE FOR MOVING A FURNITURE PART THAT IS MOVABLY MOUNTED RELATIVE TO A FURNITURE CARCASS

(71) Applicant: Julius Blum GmbH, Hoechst (AT)

(72) Inventor: Juan Jesus PEDROSA FERNANDEZ, Dornbirn (AT)

(21) Appl. No.: 18/916,170

(22) Filed: Oct. 15, 2024

Related U.S. Application Data
(63) Continuation of application No. PCT/AT2023/060080, filed on Mar. 20, 2023.

(30) Foreign Application Priority Data
May 23, 2022 (AT) GM 50086/2022

(51) Int. Cl. E05D 15/40; E05F 1/12

(52) U.S. Cl. CPC E05D 15/401; E05F 1/12; E05Y 2900/20

(57) ABSTRACT

A furniture drive includes an adjustment device having a rotatably-supported adjustment element, a transmission mechanism for transmitting a force of the adjustment element, an overload safety device configured to couple the adjustment element with the transmission mechanism upon a rotation of the adjustment element with a torque below a predetermined limit torque. The overload safety device is further configured to decouple the adjustment element from the transmission mechanism upon a rotation of the adjustment element with a torque above the limit torque, preferably such that no torque transmission between the adjustment element and the transmission mechanism takes place. The overload safety device includes a first component having a longitudinal direction and a second component configured to be moved in a direction extending transversely to the longitudinal direction of the first component when the torque is above the limit torque.

### BACKGROUND OF THE INVENTION

The present invention relates to a furniture drive for moving a furniture part movably-supported relative to a furniture carcass. The furniture drive Includes an adjustment device having at least one rotatably-supported adjustment element, a transmission mechanism for transmitting a force of the adjustment element, and at least one overload safety device configured to couple the adjustment element with the transmission mechanism upon a rotation of the adjustment element with a torque below a predetermined limit torque. The overload safety device is configured to decouple the adjustment element from the transmission mechanism upon a rotation of the adjustment element with a torque above the limit torque, preferably such that no torque transmission between the adjustment element and the transmission mechanism takes place.

Moreover, the invention concerns an item of furniture comprising a furniture carcass, a furniture part movably-supported relative to the furniture carcass, and a furniture drive of the type to be described.

AT 524391 A1 discloses a furniture drive comprising an actuating arm assembly for moving a movable furniture part, and an adjustment device for adjusting a force to the actuating arm assembly. The adjustment device includes a rotatable adjustment element, and a force of the spring device to the actuating arm assembly is adjustable by rotating the adjustment element. The furniture drive further includes an overload safety device configured to decouple the adjustment element from a transmission mechanism in the case when the adjustment element is rotated with a torque above a predetermined limit torque. This overload safety device is, in particular, useful when the adjustment element is driven with a high torque with the aid of a rotational tool in the form of a cordless screwdriver. The overload safety device includes a rotatable shaft having a first tooth arrangement which is pressed, by a force of a spring element, against a corresponding second tooth arrangement of the adjustment element in an axial direction of the shaft. A drawback is the fact that the manufacturing of the two tooth arrangements is relatively complicated. For a durable function of the overload safety device, the tooth arrangements shall consist of a metal which has to be milled and hardened. Moreover, the co-operating tooth arrangements only allow small tolerances and must be very precisely produced for this purpose. This leads, of course, also to increased costs in the serial production of the furniture drives.

Furniture drives with an overload safety device are also disclosed in EP 3 708 753 A1 and in WO 2020/232483 A1.

WO 2020/232485 A1 discloses a furniture drive for moving a movably-supported furniture flap, in which a housing of the furniture drive is configured to be integrated into a furniture panel of the furniture carcass.

### SUMMARY OF THE INVENTION

It is an object of the present invention to propose a furniture drive mentioned in the introductory part, thereby avoiding the above-discussed drawbacks.

According to the invention, the overload safety device includes a first component having a longitudinal direction, and at least a second component. The second component is configured to be moved at least in a direction extending transversely to the longitudinal direction of the first component when the torque is above the limit torque.

In other words, the overload safety device includes at least two components movable relative to each other, the components being coupled in a first operating position in which a torque transmission between these components is established.

Upon a rotation of the adjustment element with a torque above the limit torque, the second component is movable in a direction extending transversely to the longitudinal direction of the first component (thus in a radial direction) into a second operating position, in which the two components are decoupled from each other such that no transmission of force takes place. This has the advantage that it is not necessary for the two components of the overload safety device to be pressed against each other in an axial direction by the spring element. Instead, the second component is deflected in a radial direction with respect to the longitudinal direction of the first component in an overload case.

The first component and the second component can be configured as components separate from each other, or can formed together so has to have an integral one-piece configuration. Preferably, the first component and the second component are connected to each other by at least one film hinge.

According to an embodiment, at least one holding element can be provided, the holding element being configured to hold the first component and the second component relative to each other in a coupling position when the torque is below the limit torque.

According to a further embodiment, the at least one holding element can include at least one spring element configured to apply a force to the second component in a direction of the first component.

The furniture drive can be utilized for driving movable furniture parts, in particular doors, flaps or drawers, or also for driving other movable elements, such as windows for example.

### BRIEF DESCRIPTION OF THE DRAWINGS

Further details and advantages of the present invention will be explained with the aid of the following description of figures, in which:

FIG. 1a, 1b show an item of furniture comprising a movable furniture part in a perspective view and in an exploded view,

FIG. 2a, 2b show a furniture drive in two different perspective views,

FIG. 3a, 3b show the furniture drive in a closed position and in an open position,

FIG. 4a, 4b show an adjustment device with an overload safety device in two different views,

FIG. 5a-5d show different views of the overload safety device in a coupling position, and

FIG. 6a-6c show different views of the overload safety device in a decoupling position, and the overload safety device in an exploded view.

### DETAILED DESCRIPTION OF THE INVENTION

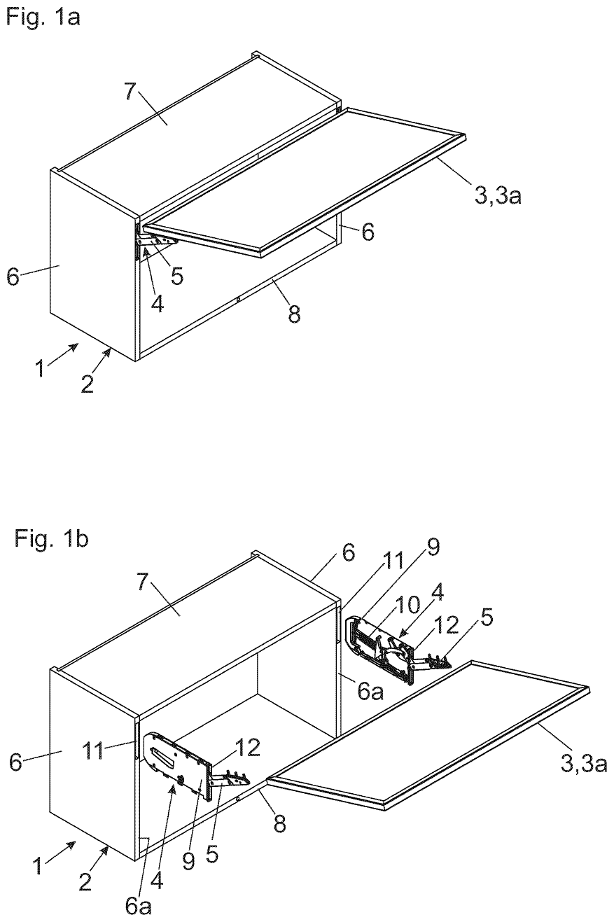

FIG. 1a shows a perspective view of an item of item of furniture 1 comprising a furniture carcass 2, a furniture part 3 movably-supported relative to the furniture carcass 2, and at least one furniture drive 4 for moving the movable furniture part 3. The item of furniture 1 includes furniture panels 6 in the form of sidewalls, a top panel 7 and a bottom panel 8. In the shown embodiment, the furniture part 3 is in the form of a furniture flap 3a configured to be lifted relative to the furniture carcass 2.

In the shown embodiment, the furniture drive 4 is at least partially, preferably substantially entirely, integrated into a furniture panel 6 of the furniture carcass 2. Of course, the furniture drive 4 can also be arranged outside a wall thickness of the furniture panel 6.

The movable furniture part 3 is movably supported relative to the furniture carcass 2 between a closed position in which the furniture carcass 2 is covered, and an elevated open position.

Of course, it is also possible to integrate the furniture drive 4 into a horizontally extending furniture panel, thus for example into the top panel 7, into the bottom panel 8 and/or into a shelf arranged between the top panel 7 and the bottom panel 8. In such a case, the movable furniture part 3 is pivotally supported about a vertically extending axis relative to the furniture carcass 2 in a mounted position.

The furniture drive 4 includes an actuating arm assembly 5 for moving the movable furniture part 3, and at least one spring device 10 (FIG. 1b) configured to apply a force to the actuating arm assembly 5.

FIG. 1b shows the item of furniture 1 in an exploded view, in which two furniture drives 4, preferably identical in construction, are provided for moving the movable furniture part 3. Each of the furniture drives 4 includes a housing 9 configured to be fixed to the furniture carcass 2.

According to an embodiment, the housing 9 is at least partially, preferably substantially entirely, received within a recess 11 of the furniture panels 6 configured as sidewalls in a mounted condition. In a mounted condition, the housing 9 can be arranged substantially flush with a front face 6a of the furniture panel 6.

For example, the recess 11 can be in the form of a blind hole, and the housing 9 is insertable from the front when being mounted (that is to say from the narrow front face 6a of the furniture panel 6) into the pocket-shaped recess 11 of the furniture panel 6.

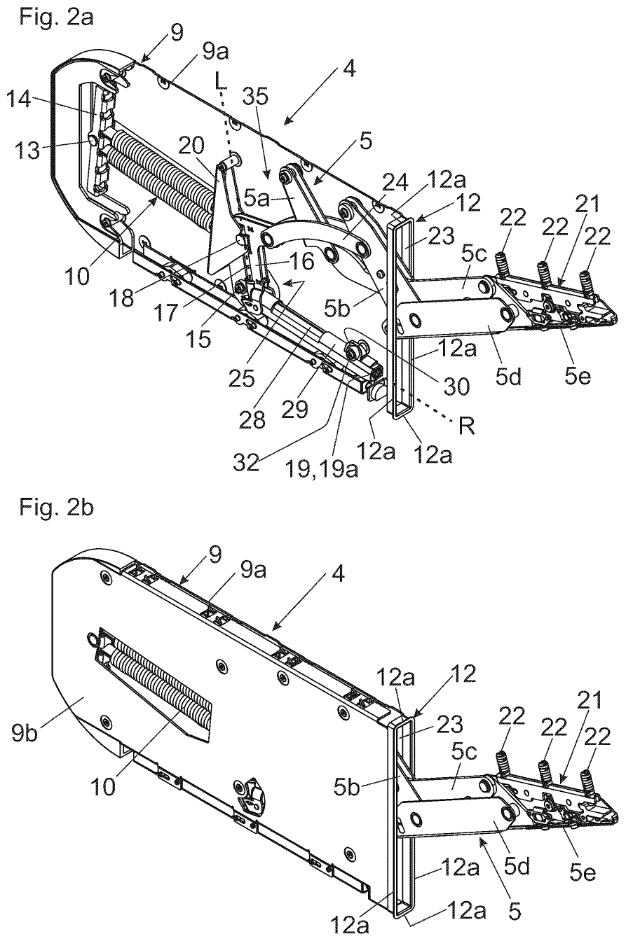

A cover 12 is provided on the front-end region of the housing 9, and at least one movably-supported actuating arm 5a, 5b, 5c, 5d, 5e (FIG. 2a) of the actuating arm assembly 5 can be guided through the cover 12 in a relative position.

FIG. 2a shows the furniture drive 4 in a perspective view, in which the housing 9 includes at least one flat-shaped housing wall 9a configured to bear against the furniture carcass 2. A pivotable bearing portion 14 is provided on the housing wall 9a, the bearing portion 14 being pivotally supported about a hinge axis 13 stationarily arranged on the housing 9. A first end region of the spring device 10 is thus supportable on the stationary hinge axis 13. The spring device 10 can include at least one helical spring, preferably at least one compression spring, or, alternatively, a gas pressure spring.

The furniture drive 4 includes a transmission mechanism 35 which, for example, can be provided for transmitting a force from the spring device 10 to the actuating arm assembly 5.

In the shown embodiment, a second end region of the spring device 10 operates on a pressure portion 20. The pressure portion 20 is hingedly connected via an adjustable engagement location 18 to an intermediate lever 16 pivotable about a, preferably stationary, hinge axis 15.

By an adjustment device 19, a force of the spring device 10 to the actuating arm assembly 5 is adjustable. The adjustment device 19 includes an adjustment element 19a rotatable about a rotational axis R. A position of the engagement location 18 of the spring device 10 relative to the actuating arm assembly 5 is adjustable, preferably along a threaded portion 17, by rotating the adjustment element 19a about the rotational axis R.

The threaded portion 17 has a longitudinal axis L. The angle, that the longitudinal axis L of the threaded portion 17 and the rotational axis R of the adjustment element 19a enclose relative to each other, can be varied upon a movement of the actuating arm assembly 5. By an angularly-movable coupling device 25, a rotational movement of the adjustment element 19a can be transmitted to the threaded portion 17. As a result, the threaded portion 17 can be set into a rotational movement and thus the engagement location 18 is movable along the threaded portion 17.

The angularly-movable coupling device 25 can include at least one elastic element, preferably a folding bellows, a rubber form element, a coil spring coupling, and/or at least one gear, preferably a bevel gear transmission, and/or a joint, preferably a cross-joint or a cardan joint. Due to the angularly-movable coupling device 25, a very compact arrangement can be made possible, because the components of the furniture drive 4 can be nested into each other.

Preferably, the adjustment element 19a of the adjustment device 19, in a mounted condition of the furniture drive 4, faces towards the movable furniture part 3 and is arranged in a front-end region of the housing 9. In this way, the adjustment element 19a can be comfortably actuated from the front with the aid of a tool.

In the shown embodiment, at least one shaft 28 for driving the threaded portion 17 is provided, the at least one shaft 28 being configured to be driven by the adjustment element 19a. The at least one shaft 28 is displaceably supported relative to the housing 9 in or along a guide 30, preferably an elongated hole. In this way, compensation movements of components of the furniture drive 4, caused by the angularly-movable coupling device 25, can be at least partially compensated for.

The shaft 28 is arranged in or on a bearing device 29. The guide 30 is arranged on the bearing device 29, and a pin 32 stationarily supported on the housing 9 engages into the guide 30 of the bearing device 29. Upon a compensation movement, the bearing device 29 is movable relative to the stationary pin 32.

The actuating arm assembly 5 includes at least one actuating arm 5a, 5b, 5c, 5d, 5e, preferably a plurality of actuating arms 5a, 5b, 5c, 5d, 5e, for moving the movable furniture part 3. A fitting portion 21 is to be fixed to the movable furniture part 3, the fitting portion 21 having at least one or a plurality of fastening locations 22 and being configured to be releasably locked to an actuating arm 5e of the actuating arm assembly 5. In FIG. 2a, the locked condition between the actuating arm 5e and the fitting portion 21 is shown.

A cover 12 is provided on the front-end of the housing wall 9a, the cover 12 having at least one laterally protruding flange 12a. In the shown embodiment, the flange 12a is substantially ring-shaped and forms a depth stop for the housing 9, the depth stop being configured to bear against the front face 6a of the furniture panel 6.

FIG. 2b shows the furniture drive 4 according to FIG. 2a, in which the housing 9 is closed by the second housing wall 9b. The first housing wall 9a and the second housing wall 9b are each flat and jointly form a substantially cuboidal housing 9. The housing walls 9a, 9b are spaced apart from each other in a parallel relationship, and a front-sided opening 23 is formed between the housing walls 9a, 9b.

The cover 12 is arranged adjacent to the opening 23 and allows the passage of a screwdriver for the adjustment device 19 to be actuated.

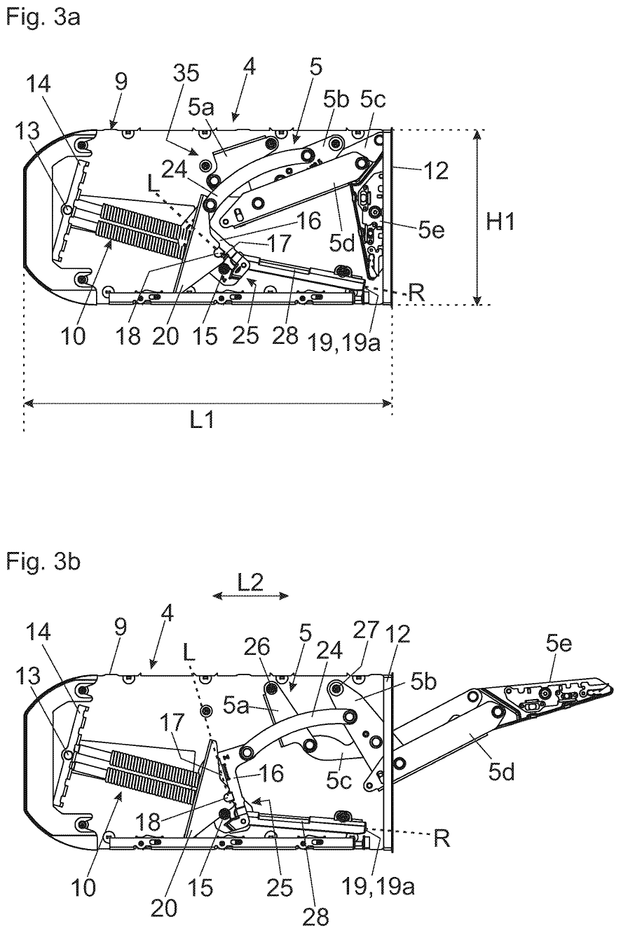

FIG. 3a shows the furniture drive 4 with the housing 9 in a side view. The threaded portion 17 is arranged on an intermediate lever 16, the intermediate lever 16 being pivotally supported about a stationary hinge axis 15 on the housing 9. In the shown figure, the spring device 10 applies a minimum torque to the actuating arm assembly 5, because the engagement location 18 of the spring device 10 is located adjacent to the hinge axis 15 of the intermediate lever 16. A notional connecting line between the hinge axis 15 of the intermediate lever 16 and the engagement location 18 of the spring device 10 forms a relatively short lever arm. Therefore, a minimum torque acts on the actuating arm assembly 5.

The rotational axis R of the adjustment element 19a of the adjustment device 19 and the longitudinal direction L of the threaded portion 17 enclose an angle relative to each other, the angle being variable upon a movement of the actuating arm assembly 5. An advantage of this construction can be seen with the aid of FIG. 3a, because in the shown closed position of the furniture drive 4, due to the angularly-movable arrangement of the rotational axis R and the longitudinal direction L, the actuating arms 5a-5e of the actuating arm assembly 5, jointly with the spring device 10 and the adjustment device 19, can achieve a very compact position relative to each other.

The adjustment element 19a and the rotatable threaded portion 17 are thus angularly-movably supported relative to each other upon a movement of the actuating arm assembly 5. As a result, the adjustment device 19 for adjusting a force of the spring device 10 and the actuating arm assembly 5 can achieve different positions to each other. The components of the furniture drive 4 can be nested into each other and, therefore, can be arranged tighter to each other. In this way, the furniture drive 4 can be designed in a more compact manner, the adjustment path of the spring device 10 along the threaded portion 17 can be increased, and higher performance ranges of the furniture drive 4 can be provided.

The housing 9 can be substantially cuboidal. Preferably, a ratio of a length L1 of the housing 9 to a height H1 of the housing 9 is larger than 1 to 0.7, preferably larger than 1 to 0.5. Due to such a dimensioning, a reduced height H1 of the housing 9 can be provided. In this way, the height of the recess 11 (FIG. 1b) of the furniture panel 6 can also be kept small, and the manufacturing efforts for producing the recess 11 and a weakening of the furniture panel 6 are minor.

FIG. 3b shows the furniture drive 4 according to FIG. 3a with a minimum force adjustment of the spring device 10, in which the actuating arm assembly 5 with the actuating arms 5a-5e is located in an open position. It is evident that the angle, that the rotational axis R and the longitudinal direction L of the threaded portion 17 enclose to each other, has been decreased with respect to the closed position shown in FIG. 3a.

The actuating arm assembly 5 includes a first actuating arm 5a pivotable about a first hinge axis 26, and at least one second actuating arm 5b pivotably supported about a second hinge axis 27. The first hinge axis 26 and the second hinge axis 27 are spaced apart from each other along a longitudinal direction L2 of the housing 9, and the second hinge axis 27 is arranged in a front region of the housing 9 with respect to the first hinge axis 26.

The intermediate lever 16 is directly connected to the second (frontal) actuating arm 5b via a, preferably curved-shaped, pushing lever 24. The first actuating arm 5a is thus not directly connected to the pushing lever 24 via a hinge axis. Instead, the first actuating arm 5a is displaceably guided within the pushing lever 24. This can be well seen in FIG. 2a. In this way, an improved and direct introduction of force of the spring device 19 into the actuating arm assembly 5 can be provided.

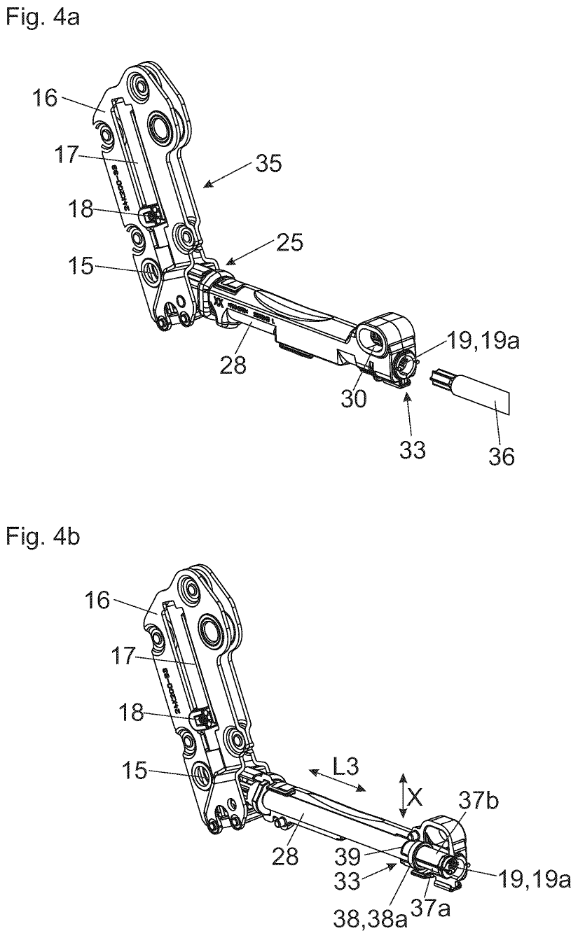

FIG. 4a shows the adjustment device 19 with the rotatable adjustment element 19a and an overload safety device 33. The overload safety device 33 is configured such that upon a movement of the adjustment element 19a with a torque below a predetermined limit torque, the adjustment element 19a is coupled to the transmission mechanism 35. Upon a rotation of the adjustment element 19a with a torque above a predetermined limit torque, the adjustment element 19a can be decoupled from the transmission mechanism 35 by virtue of the overload safety device 33.

By a rotational tool 36, for example a cordless screwdriver, the adjustment element 19a can be driven. The rotational movement of the adjustment element 19a can be transmitted to the shaft 28, and the threaded portion 17 can be set into a rotational movement via the angularly-movable coupling device 25. As a result, the engagement location 18 of the spring device 10 is movable along the threaded portion 17. In the shown embodiment, the threaded portion 17 is supported on the intermediate lever 16 pivotable about the hinge axis 15.

FIG. 4b shows the view according to FIG. 4a, in which a housing portion is not depicted so as to illustrate the overload safety device 33 in greater detail. The overload safety device 33 includes a first component 37a having a longitudinal direction L3 and a second component 37b. The components 37a, 37b are movable relative to each other between a coupling position and a decoupling position.

Upon rotating the adjustment element 19a with a torque below a predetermined limit torque, the adjustment element 19a is coupled to the transmission mechanism 35.

Upon rotating the adjustment element 19a with a torque above the predetermined limit torque, the adjustment element 19a can be decoupled from the transmission mechanism 35, namely in that the second component 37b is movable relative to the first component 37a at least in a direction X extending transversely to the longitudinal direction L3 of the first component 37a.

According to possible embodiments, the first component 37a and/or the second component 37b
is or are substantially cylindrical at least over a region, and/or
collectively form a substantially cylindrical shape, and/or
is or are made of plastic, and/or
is or are produced by an injection molding process.

The two components 37a, 37b can be configured as components 37a, 37b separate from each other. According to an alternative embodiment, the two components 37a, 37b can be connected to each other via at least one film hinge 39.

In the shown embodiment, at least one holding element 38 is provided, the holding element 38 being configured to hold the first component 37a and the second component 37b relative to each other in a coupling position when the torque is below the limit torque.

The at least one holding element 38 can include at least one spring element 38a for pressurizing the second component 37b with a force in a direction of the first component 37a. Preferably, the spring element 38a:
is ring-shaped at least over a region (i.e., at least partially), and/or
is configured as an O-ring, and/or
is hollow-cylindrical at least over a region, and/or
has a width between 0.1 mm and 3.0 mm, preferably a width of 2.0 mm, and/or
has a wall thickness between 0.1 mm and 2.0 mm, preferably a wall thickness of 1.0 mm, and/or
has an outer diameter of less than 8.0 mm, preferably of less than 7.5 mm, particularly preferably of less or equal than 7.0 mm, and/or
consists of plastic, preferably POM and/or TPU, and/or
is produced by an injection molding process, and/or
is configured to be, preferably elastically, widened at least partially in a radial direction.

In the shown embodiment, the first component 37a of the overload safety device 33 and the shaft 28 are formed together so as to have an integral one-piece configuration. However, the component 37a and the shaft 28 can also be configured as components separate from each other.

The adjustment element 19a of the adjustment device 19 and at least one component 37a, 37b, preferably both components 37a, 37b, can be formed together so as to have an integral one-piece configuration. As a result, the arrangement of an adjustment element 19a separate from the components 37a, 37b can be omitted. Of course, an adjustment element 19a separate from the components 37a, 37b may also be provided.

According to an embodiment, the holding element 38 is displaceably supported relative to the first component 37a and/or relative to the second component 37b at least over a region in a direction extending in the longitudinal direction L3 of the first component 37a. Preferably, the limit torque is adjustable by a displacement of the holding element 38.

According to an embodiment, the limit torque is between 0.5 Nm and 4.0 Nm, preferably between 0.8 Nm and 1.2 Nm.

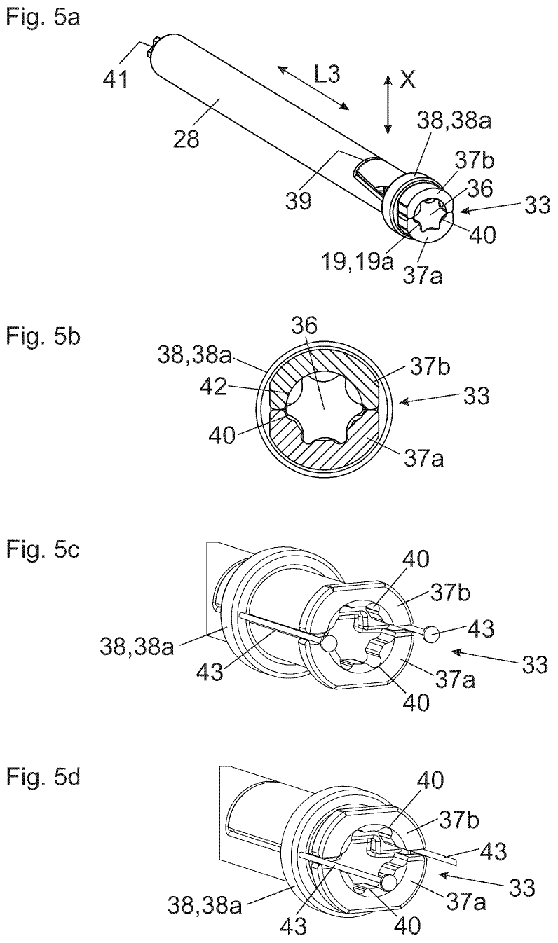

FIG. 5a-5d show the overload safety device 33 in different views.

FIG. 5a shows a perspective view of the two components 37a, 37b of the overload safety device 33, in which the rotational tool 36 is introduced into the two components 37a, 37b. By rotating the rotational tool 36, at least one of the two components 37a, 37b can be driven.

The first component 37a and the shaft 28 can be formed together so as to have an integral one-piece configuration. Alternatively, it is also possible that the first component 37a and the shaft 28 are configured as elements separate from each other.

The first component 37a can include at least one tooth arrangement 41 configured to transmit a rotational movement of the first component 37a to the other components of the transmission mechanism 35 of the furniture drive 4.

The first component 37a and the second component 37b can be configured as components 37a, 37b separate from each other. Alternatively, it is also possible that the first component 37a and the second component 37b are formed together so as to have an integral one-piece configuration.

For example, the first component 37a and the second component 37b are connected to each other via at least one film hinge 39.

Due to the holding element 38, the two components 37a, 37b can be held in coupling position relative to each other so as to transmit a torque to the shaft 28, when the torque is below the limit torque.

The adjustment element 19a of the adjustment device 19 can include at least one actuating contour 40. Preferably, the actuating contour 40:
includes at least partially a hexagon-profile, and/or
has a diameter of less or equal than 3.86 mm, and/or
is only arranged on the first component 37a, and/or
is at least partially arranged on the first component 37a and at least partially on the second component 37b, and/or
is arranged on a front face of the adjustment element 19a.

FIG. 5b shows the embodiment of the overload safety device 33 according to FIG. 5a in a cross-sectional view. To be seen is the rotational tool 36 introduced into the two components 37a, 37b. Here, only the first component 37a includes an actuating contour 40 for the rotational tool 36. On the contrary, the second component 37b includes a circular inner contour 42. Accordingly, a rotational movement of the rotational tool 36 is only transmitted to the first component 37a. In this way, a lesser torque can be transmitted, so that the limit torque of the overload safety device 33 can be reduced for different applications.

FIG. 5c shows an embodiment of an overload safety device 33, in which the holding element 38 is located in a rear-end position relative to the two components 37a, 37b.

The holding element 38 can be displaceable relative to the first component 37a and/or relative to the second component 37b by at least one actuating device 43. In this way, the limit torque of the overload safety device 33 is adjustable.

According to possible embodiments:
the at least one actuating device 43 is configured to be actuated from a direction extending parallel and/or transversely to the longitudinal direction L3 of the first component 37a, and/or
the furniture drive 4 includes a housing 9, and the overload safety device 33 is arranged in the housing 9 and the holding element 38 is configured to be actuated from an external side of the housing 9 via the actuating device 43.

Preferably, the holding element 38 is accessible for manual actuation via the actuating device 43 from the front face of the furniture panel 6 when the furniture drive 4 is arranged on or within the furniture panel 6.

For example, the actuating device 43 can include a displaceable and/or a pivotable actuating element configured to adjust a position of the holding element 38. For example, the actuating element of the actuating device 43 can be arranged on the housing 9 of the furniture drive 4, preferably on the frontal front face of the housing 9.

FIG. 5d shows the embodiment of the overload safety device 33 according to FIG. 5c, in which the holding element 38, preferably in the form of the spring element 38a, is located in a frontal end position relative to the two components 37a, 37b. In the position according to FIG. 5d, a higher torque can be transmitted in a direct comparison with FIG. 5c.

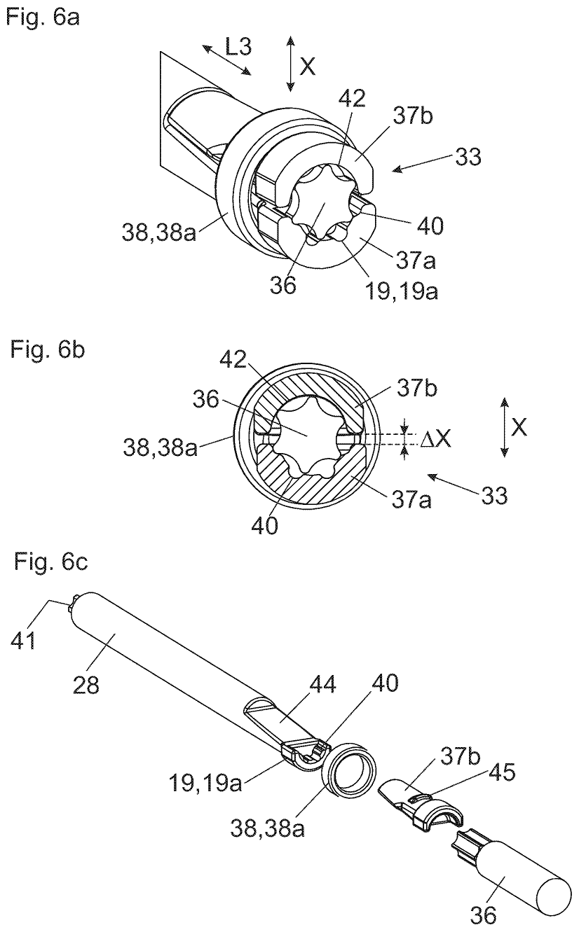

FIG. 6a shows a perspective view of the overload safety device 33 in a decoupling position, in which the transmission of torque is interrupted. It can be seen that the rotational tool 36 is introduced into the two components 37a, 37b, the rotational tool 36 being rotated here with a torque above the predetermined limit torque.

In this case, the rotational tool 36 slips from the actuating contour 40 of the first component 37a, and the protrusions of the rotational tool 36 are no longer in engagement with the corresponding recesses of the actuating contour 40. After the release of a holding force predetermined by the holding element 38, the second component 37b is lifted from the first component 37a in the direction X so as to interrupt the transmission of a torque.

The first component 37a and the second component 37b are arranged in a coupling position relative to each other when the torque is below the limit torque, and are arranged in a decoupling position relative to each other when the torque is above the limit torque. In the decoupling position, the two components 37a, 37a are further spaced apart from each other along a direction X extending transversely to the longitudinal direction L3 of the first component 37a than in the coupling position.

FIG. 6b shows the overload safety device 33 according to FIG. 6a in a cross-sectional view. It can be seen that the second component 37b has been moved, under the formation of a gap, by the differential amount ΔX relative to the first component 37a in a direction X extending transversely to the longitudinal direction L3 of the first component 37a, when the admissible limit torque is exceeded, and the rotational tool 36 is no longer in engagement with the actuating contour 40 of the first component 37a.

FIG. 6c shows the overload safety device 33 in an exploded view. The first component 37a can include at least one recess 44 in which the second component 37b can be at least partially arranged. However, the arrangement of a film hinge 39 for hingedly connecting the two components 37a, 37b can be basically omitted.

At least one abutment element 45 can be arranged on the first component 37a and/or on the second component 37b, the at least one abutment element 45 being configured to limit a movement of the holding element 38 in the longitudinal direction L3 of the first component 37a.

1. A furniture drive for moving a furniture part movably-supported relative to a furniture carcass, the furniture drive comprising:
an adjustment device having at least one rotatably-supported adjustment element,
a transmission mechanism for transmitting a force of the adjustment element,
at least one overload safety device configured to couple the adjustment element with the transmission mechanism upon a rotation of the adjustment element with a torque below a predetermined limit torque, and being configured to decouple the adjustment element from the transmission mechanism upon a rotation of the adjustment element with a torque above the limit torque, preferably such that no torque transmission between the adjustment element and the transmission mechanism takes place,
wherein the overload safety device includes a first component having a longitudinal direction and at least a second component, the second component being configured to be moved at least in a direction extending transversely to the longitudinal direction of the first component when the torque is above the limit torque.

2. The furniture drive according to claim 1, wherein the first component and/or the second component:
is or are at least partially substantially cylindrical, and/or
collectively form a substantially cylindrical shape, and/or
is or are made of plastic, and/or
is or are produced by an injection-molding process.

3. The furniture drive according to claim 1, wherein the first component includes at least one recess configured to at least partially receive the second component.

4. The furniture drive according to claim 1, wherein the first component and the second component are configured as components separate from each other, or are formed together so as to have an integral one-piece configuration, preferably wherein the first component and the second component are connected to each other via at least one film hinge.

5. The furniture drive according to claim 1, further comprising at least one holding element configured to hold the first component and the second component relative to each other in a coupling position when the torque is below the limit torque, preferably wherein at least one abutment element is arranged on the first component and/or on the second component, the at least one abutment element being configured to limit a movement of the holding element in the longitudinal direction of the first component.

6. The furniture drive according to claim 5, wherein the at least one holding element includes at least one spring element configured to pressurize the second component in a direction of the first component, preferably wherein the spring element:
is at least partially ring-shaped, and/or
is configured as an O-ring, and/or
is at least partially hollow cylindrical, and/or
has a width between 0.1 mm and 3.0 mm, preferably a width of 2.0 mm, and/or has a wall thickness between 0.1 mm and 2.0 mm, preferably a wall thickness of 1.0 mm, and/or
has an outer diameter of less than 8.0 mm, preferably of less than 7.5 mm, particularly preferable of less or equal than 7.0 mm, and/or
consists of plastic, preferably POM and/or TPU, and/or
is produced by an injection molding process, and/or
is configured to be at least partially, preferably elastically, widened in a radial direction.

7. The furniture drive according to claim 5, wherein the at least one holding element is at least partially displaceably supported in the longitudinal direction of the first component relative to the first component and/or relative to second component, preferably wherein the limit torque is adjustable by a displacement of the at least one holding element.

8. The furniture drive according to claim 7, further comprising at least one actuating device for displacing the holding element relative to the first component and/or relative to the second component, preferably wherein:
the at least one actuating device is configured to be actuated from a direction extending parallel and/or transversely to the longitudinal direction of the first component, and/or
the furniture drive includes a housing, wherein the overload safety device is arranged in the housing, and the holding element can be actuated from an external side of the housing via the actuating device.

9. The furniture drive according to claim 1, wherein the overload safety device is configured such that the limit torque is between 0.5 Nm and 4.0 Nm, preferably between 0.8 Nm and 1.2 Nm.

10. The furniture drive according to claim 1, wherein the first component and the second component are arranged relative to each other in a coupling position when the torque is below the limit torque, and are arranged in a decoupling position when the torque is above the limit torque, wherein the two components, in the decoupling position, are further spaced apart from each other in a direction extending transversely to the longitudinal direction of the first component than in the coupling position.

11. The furniture drive according to claim 1, wherein the adjustment element and the first component and/or the second component are formed together so as to have an integral one-piece configuration, or that the adjustment element and the two components are separate from each other.

12. The furniture drive according to claim 1, wherein the adjustment element includes at least one actuating contour, preferably wherein the actuating contour:
includes at least partially a hexagon-profile, and/or
has a diameter of less or equal than 3.86 mm, and/or
is only arranged on the first component, and/or
is at least partially arranged on the first component and at least partially on the second component, and/or
is arranged on a front face of the adjustment element.

13. The furniture drive according to claim 1, wherein the furniture drive:
includes an actuating arm assembly having at least one movably-supported actuating arm for moving the movable furniture part,
includes at least one spring device for applying a force to the actuating arm assembly, wherein the spring device is connected to the actuating arm assembly via at least one engagement location,
wherein upon a rotation of the adjustment element, a relative position of the at least one engagement location with respect to the actuating arm assembly is adjustable.

14. The furniture drive according to claim 13, further comprising at least one threaded portion having a longitudinal direction, wherein the engagement location of the spring device along the threaded portion is adjustable by rotating the adjustment element about a rotational axis, preferably wherein the rotational axis of the adjustment element and the longitudinal direction of the threaded portion enclose an angle relative to each other, wherein that angle, that the rotational axis of the adjustment element and the longitudinal direction of the threaded portion enclose relative to each other, can be varied by an angularly-movable coupling device upon a movement of the actuating arm assembly.

15. An item of furniture comprising a furniture carcass, a furniture part movably-supported relative to the furniture carcass, and at least one furniture drive according to claim 1 for moving the movable furniture part, preferably wherein the furniture carcass includes a furniture panel for fixing the housing, wherein the housing of the furniture drive is at least partially, preferably substantially entirely, received within a recess of the furniture panel.
